(19) United States
(12) Patent Application Publication
(10) Pub. No.: US 2005/0103776 A1
(43) Pub. Date: May 19, 2005

(54) Low-intensity infrared heating

(76) Inventors: Claus Nielson, Provo, UT (US); W. Spencer Guthrie, Provo, UT (US)

Correspondence Address: RADER, FISHMAN & GARAUER PLLC, 10653 SOUTH RIVER FRONT PARKWAY, SUITE 150, SOUTH JORDAN, UT, 84095, US

(21) Appl. No.: 10/933,576

(22) Filed: Sep. 2, 2004

Related U.S. Application Data
(60) Provisional application No. 60/499,902, filed on Sep. 2, 2003.

(51) Int. Cl. H05B 1/00

(52) U.S. Cl. 219/553; 219/213

(57) ABSTRACT

A method for preparing or maintaining surfaces for construction-type work includes using at least one low-intensity infrared radiation heat source placed near the surface. The infrared radiation can warm the surface in preparation for the construction activity. Additionally, the radiation can be used to maintain the surface in a state that is conducive to construction activity. This type of treatment may be particularly useful in colder climates, where the weather affects the construction season.

### CROSS-REFERENCE TO RELATED APPLICATION

The present application claims priority under 35 U.S.C. § 119(e) from U.S. Provisional Patent Application Ser. No. 60/499,902, filed 2003 Sep. 02 by the present inventors, which is incorporated herein by reference in its entirety.

### BACKGROUND

In cold-regions climates, the construction season is ideally concentrated in warmer months during which frost does not persist in the ground. Particularly with the placement of Portland cement concrete slabs on grade, construction code in many such regions requires that the ground be entirely frost-free before construction can proceed. Thus, contractors who choose to continue construction during winter weather can incur significant additional costs in labor, equipment, and fuel required for heating and insulating. These expenses reduce the profitability of their efforts and can markedly increase the overall costs of the projects undertaken. For these reasons, contractors in both the residential and commercial segments of the construction industry are constantly searching for cost-efficient ways of extending the construction season.

In areas which experience freezing conditions, the construction industry has always been plagued with significant seasonal production cycles. During winter, production is affected by freezing conditions which significantly impact production, employment, sales, etc. Problems are particularly experienced in the placement of concrete slabs and in other construction projects requiring curing of concrete.

Because construction codes in many areas require that the ground be frost free prior to the laying of concrete, significant problems exist for construction crews in eliminating frost and frozen ground. Similar problems exist for above-ground-level placement of concrete, such as in the construction of multi-story buildings, when temperatures fall below 5° C. Two choices are typically available to the construction company when faced with the afore-mentioned situations: apply expensive methods to prepare the construction site such as the use of thermal blankets, excavate and replace the ground, use propane blowers, use heated glycol, or postpone the job and incur obvious costs and potential loss of business.

Construction companies operating in areas affected by freezing conditions are directly affected during the months of winter. Cement chemically reacts with water to produce calcium silicate hydrate, the chemical compound that makes concrete hard and strong. Temperature mainly determines the speed of this hydration reaction. The speed of the hydration reaction, then, determines the time required for concrete to set and develop strength.

If production continues, significant winterizing costs are incurred that are passed on to the consumer. The adverse impacts of freezing conditions on construction companies can include (a) lower production and subsequent loss of income; (b) loss of trained personnel, which then requires rehiring and retraining new employees each year; (c) uneven seasonal cash flow; (d) delayed production while waiting for warmer weather; and, (e) increased cost to the consumer or contractor.

When the ambient temperature falls below 5° C., successful concrete placement typically requires special construction procedures. As mentioned earlier, lower temperatures will prevent concrete from setting altogether. This problem is due to heat loss in concrete when the concrete is poured onto very cold surfaces. The frozen ground rapidly absorbs heat from the concrete. To reduce the problem, concrete is often prepared using heated water and additional materials to encourage hydration. Other types of construction activities are similarly affected by the cold temperatures. Drywall and rendering materials, in particular, require significant heating to encourage drying or setting. These practices incur additional labor costs due to considerably longer setting and curing times.

The desire to continue to work through the winter months has motivated contractors to develop various methods to combat the cold. A typical winter procedure is to thaw the ground using thermal blankets. The blankets are placed on the ground to keep the cold night air away from the ground and are then rolled back during the day to work. The thermal blankets can also be placed on poured concrete to aid in the curing period. Unfortunately, the subsequent covering of concrete flatwork with thermal blankets causes discoloration and at times surface deformation, as lower materials haven't hardened sufficiently. The process using thermal blankets is most effective on clear sunny days, where the sun can aid in the warming of the ground and delays may be caused by inclement weather. Additionally, moving the blankets at the start and end of each day requires additional labor and is, therefore, a greater time commitment.

Another procedure is to remove the frozen ground using heavy earth-moving equipment and replace the excavated material with open graded gravel. Open-graded gravel drains well and thus retains little water that can be frozen. The gravel does, however, adopt the temperature of the surrounding air, which is usually below freezing. In addition to the extra time and care required to replace the frozen ground, the excavated material must be stored somewhere until it thaws.

Yet another alternative is to use a combination of thermal blankets and tubing under the thermal blanket that carries a heated fluid (usually glycol), to thaw the ground. This process involves high establishment costs (such as transportation, expendable materials, and licensing agreements where applicable) and even higher equipment costs.

A final choice is to use propane blowers. They are rarely used to heat the ground for concreting and have proven to be greatly inefficient. Studies have shown that only 15% of the heat is actually transferred to the ground. The use of propane blowers does work well in heating the inside of a house or warehouse but consume large quantities of propane, i.e. 20 lbs in 4-6 hours. Propane blowers also burn at very hot temperatures and require regular monitoring and refueling. A house heated this way during winter for drywall taping and floating typically takes twice as long to dry in preparation for ongoing work.

Thus, there are various methods to combat the cold weather in construction, however most options either require a great time and financial commitment, or can compromise the finished product.

### SUMMARY

In one of many possible embodiments, a method is provided that includes using low-intensity infrared radiation to prepare a surface for construction-type activity. Additionally or alternatively, the infrared radiation may be used to maintain a surface that is under construction.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 is a perspective view of an example layout that can be used to prepare and maintain a ground surface for construction.

FIG. 2 is a cross-sectional view of an example layout that can be used to prepare and maintain a vertical surface for construction.

FIG. 3 is a cross-sectional view of an example layout that can be used to prepare surfaces that are elevated.

FIG. 4 is a cross-sectional of an example layout to prepare surfaces that are within a framed-in building.

FIG. 5 is a perspective view of an example of a layout that can be used to prepare surfaces progressively, where the structure is easily moved.

Throughout the drawings, identical reference numbers designate similar, but not necessarily identical, elements.

### DETAILED DESCRIPTION

Heat may be transferred by three fundamentally distinct mechanisms: conduction, convection, and radiation. Conduction is the transfer of heat from a heat source in direct contact with the object to be heated, or from one point to another within the object, in response to spatial temperature gradients. Convection is the transfer of heat from the heat source to the object being heated via a fluid medium such as air. In this case, heat transport occurs as the air moves. Radiation is the transfer of heat via electromagnetic radiation between the heat source and the object to be heated. Electromagnetic energy is emitted by all bodies above −273° C., or absolute zero, and is characterized according to wavelength. In order of increasing wavelength, these categories include gamma rays, X-rays, ultraviolet, visible light, infrared, microwave, and radio frequencies. Among these, infrared waves, which are sometimes called heat waves, have wavelengths ranging from the longest wavelength of visible light, 0.7 um, to about 1 mm. These waves are readily absorbed by most materials, causing oscillations of the infrared atoms and an increase in their vibrational or translational motion that directly results in a temperature rise.

Although most any infrared heat source should work equally as well, one possible source of the infrared radiation is an infrared tube heater. This type of heater generally consists of three main components: a burner control box, a radiant tube, and a reflector assembly. The burner control box ignites a propane-air mixture and fans the hot gases into the radiant tube. As the gases pass through the assembly, the tubing is heated and emits infrared radiation at intensity levels proportional to the temperature of the tube. There are various manufacturers that could supply an adequate heater for the function outlined within the disclosure; for example Roberts Gordon, EnerRadiant, and Superior Radiant Products.

Radiation generated by the heater is directed toward the ground by a reflector. The ground, objects, and people within the affected space absorb this primary radiation and re-radiate it as secondary infrared radiation to create a comfortable work zone. This is the mechanism by which infrared heaters can heat large spaces without having to provide primary infrared radiation for every square meter of area.

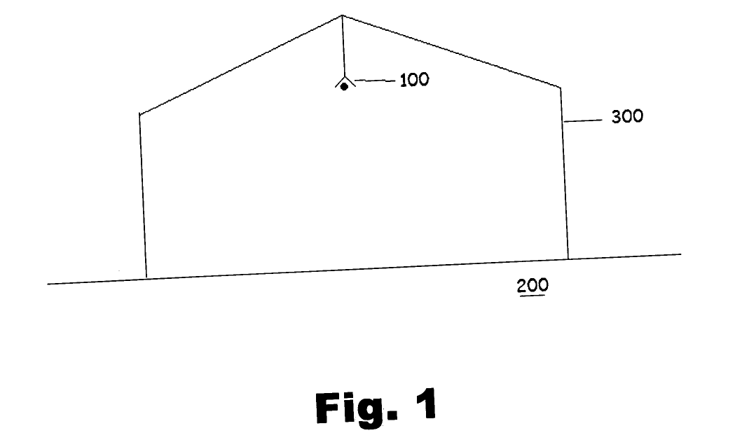

FIG. 1 is an example layout of a typical use of the infrared heating method. The infrared heat source is positioned in a way to direct as much radiation towards the surface. Depending on the layout of the area to be worked, multiple heaters may be useful. The heaters can be suspended above the surface, or attached to a platform, either stable or movable to better focus the radiation towards the surface for preparation or maintenance. If an infrared tube heater is used, there will need to be a propane supply, preferably near the heater. In this instance, the surface to be heated is the ground. The infrared heat source (100) is hung in a manner that is directed towards the surface for preparation/maintenance (200). While this heating can be used for any type of construction-activity, it is especially useful with the pouring and curing of concrete. To speed up the process, and increase the efficiency of the heaters, the area to be worked should be covered with a canopy-type structure (300). The canopy should preferably be made of a light-weight framework and serves two primary functions. The first is to support the infrared heating source(s); the second is to support a plastic cover which will further isolate the area for construction and improve the efficiency of the radiation. Variations of this set-up include differing canopy structures and/or multiple heaters.

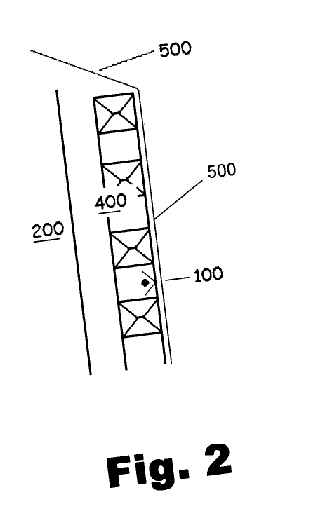

Another example layout is found in FIG. 2. This diagram details a suggested design for using the infrared radiation to prepare a vertical surface, such as a wall. To heat an outer wall (200), the heater (100) can easily be attached to scaffolding (400) at the side of a building, preferably towards the lower portion of the wall, and the scaffolding (400) is preferably covered with reinforced plastic sheeting (500) or another material of similar properties. This set-up is excellent in preparing and maintaining outer building walls for stucco application and curing, other masonry, painting, and staining.

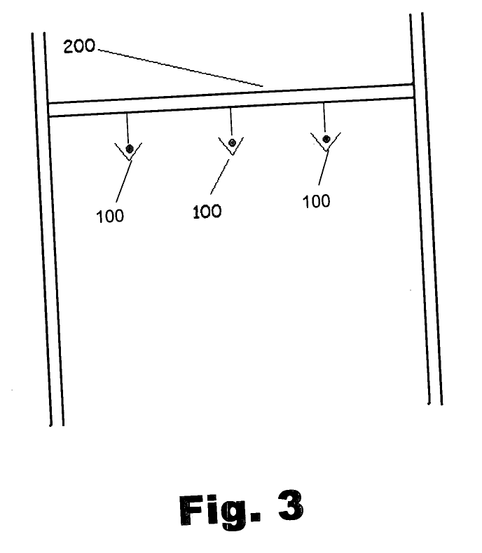

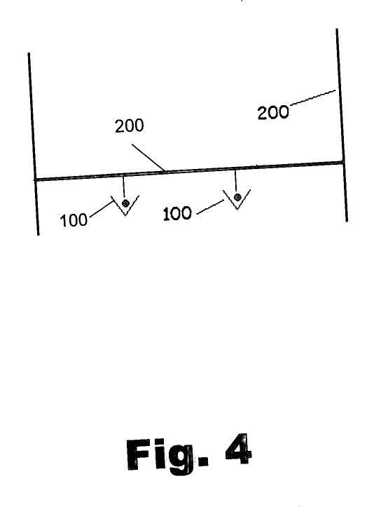

Yet another example of a use of the infrared heating system is illustrated in FIG. 3, where there is an elevated surface. Multiple heaters (100) are suspended below the surface of the construction surface (200) and angled upwards. This layout is useful particularly in industrial concreting. A similar method of heating is shown in FIG. 4, where the heaters (100) are mounted to the ceiling of a basement or cellar of a building that is mostly framed. This design can be used to prepare not only the floors of upper levels for construction-type activities, such as tiling, but it is also useful in heating the vertical surfaces for preparation of activities such as dry-walling.

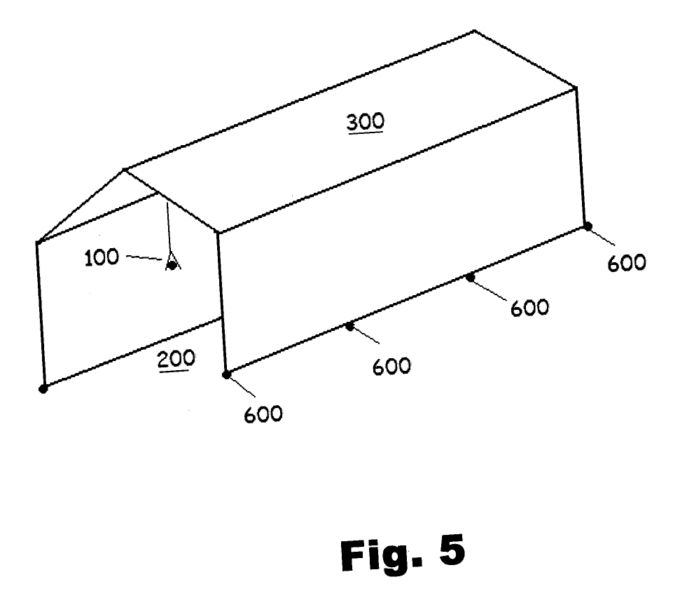

FIG. 5 illustrates a unique system that utilizes the infrared radiation from heating sources (100) to prepare a surface (200) for construction-type activities such as trenching. In this case, the canopy structure (300) is reasonably short in width and height, but long. Additionally, attached to the canopy structure (300) at the corners, and where else as needed, are objects (600) to ease in the movement of the entire canopy. These objects should be selected depending on terrain and may include wheels, skis, and skates.

Given the previous designs, experiments were conducted to verify the hypothesis that the infrared heaters, in the manner described above would indeed adequately prepare a surface for construction in a relatively short amount of time and in line with construction codes. The results of the experiments follow.

Experimental Methodology

A 22-kW (75,000-BTU) infrared tube heater available from a commercial supplier was used to induce thawing in relatively flat, level, frozen ground at two sites in northern Utah. The first site was a vacant tract of land in a residential area of Provo, Utah. The ground was surfaced with a variety of native grasses and a snow cover typically between 50 mm and 100 mm in thickness. At this site, the heater was suspended 2.0 m above the ground on a rapid-assembly canopy frame, which was then covered with reinforced plastic sheeting. The second site was a commercial building construction site in Park City, Utah, where the building walls and upper levels had been framed, but the on-grade Portland cement concrete floor slabs had not yet been placed because of the enduring presence of frost in the ground. A solid layer of ice ranging between about 75 mm and 150 mm in thickness covered the site. In this case, two heaters were hung end to end from the overhead floor joists at a height of approximately 2.4 m above the ground to induce thawing over a larger area than at site 1, and plastic sheeting was again used to enclose the site. At both sites, the heater setup required just 1 hour using a three-man crew.

A variety of measurements were obtained at both sites during the study. These included temperature readings to evaluate frost and thaw depths and ambient air conditions, dielectric and electrical conductivity profiles to assess liquid water content, and Clegg impact values (CIVs) and penetration resistance to measure soil stiffness. As thawing progresses, ground temperatures and dielectric and electric conductivity values increase, while soil stiffness decreases.

Temperatures were recorded using dataloggers attached to seven thermocouple piers placed in the ground. Three piers were installed immediately beneath the heater in each case, and the other four piers were placed in a symmetrical pattern along one side as shown in FIG. 1. Each pier was instrumented with three thermocouples at depths of 102 mm, 203 mm, and 305 mm from the ground surface, and three additional thermocouples were used to measure air temperatures. Each thermocouple pier was constructed of a 19-mm-diameter plastic pipe. Thermocouple wires were routed through the inside of the pipe and then through holes drilled at designated locations in the side of the pipe. The thermocouple ends were then glued with epoxy to the outside surface of the pipe where they would be in direct contact with the surrounding soil. Holes were made in the frozen ground using a hammer drill, and, after the piers were properly positioned, the holes were backfilled with sand.

Dielectric and electrical conductivity values were obtained using a 1.0-m downhole probe, where the former was measured at 50 MHz and the latter at 20 kHz. Both parameters increase with increasing liquid water content. The research team again used a hammer drill to create the necessary test holes.

Soil stiffness was measured using a 20.0-kg Clegg Impact Soil Tester (CIST) and a dynamic cone penetrometer (DCP). The drop height used for the CIST was 305 mm, and three sets of four drops each were averaged for reporting at each test location. The CIV obtained from the CIST is a measure of the peak deceleration of the hammer upon impact, where 1 CIV is equivalent to 10 gravities. The DCP is comprised of an 8.0-kg dual-mass slide hammer assembly used to manually drive a standard cone tip into the ground. The penetration in mm/blow is reported as a function of depth.

Temperatures were recorded throughout the heating process in 10-minute intervals, while electrical and stiffness measurements were obtained at both the beginning and end of the heating process, where possible. Soil specimens were taken from both sites to enable determinations of soil classifications and in-situ moisture contents.

Test Results

Site 1—The soil at Site 1 was characterized as OL in the Unified Soil Classification System and contained an average total gravimetric water content of 22 percent in the upper 305 mm. As measured with a nuclear density gauge, the average dry density of the soil in this zone was 2023 kg/m³. The temperature measurements obtained at this site range from 19° C. to 45° C. for the thermocouple inside above the heater and stayed near 0° C. (ranging from just below 0° C. and occasionally ranging up to 9° C. or 10° C.). The inside air temperature measured about 1.8 m above the ground. The heater was started at 3:00 p.m., 2 hours after the dataloggers began collecting data.

After just 1 hour of heating, the snow cover began to melt, exposing the underlying grass. By the next morning, or at 19 hours in the temperature charts, much of the snow was melted, with several pools of water ponded along the edge of the site. Ten hours later, the snow was entirely absent, the pools of water had either evaporated or drained, and the ground temperature at the 102-mm depth at four thermocouple sites had increased above 0° C. After another 20 hours of heating, or at about 50 hours in the charts, the ground temperature at the 203-mm depth at three of those sites had also increased above freezing. By 6 hours later, two of the sites had reached above-freezing temperatures at the 305-mm depth. By the end of the testing, all of the measurement sites showed thawing at the 102-mm depth, thawing at a depth of 203 mm or greater did not occur at the four sites most distant from the heater. As discussed earlier, the infrared radiation intensity at the exhaust end of the radiant tube is markedly less than that near the burner control box, and radiation intensity decreases with increasing radial distance from the heater.

Average thaw penetration rates for the site immediately beneath the heater were 3.8 mm/hr between the ground surface and the 102-mm depth, 4.8 mm/hr between the 102-mm and 203-mm depths, and 17.0 mm/hr between the 203-mm and 305-mm depths. Increasing thaw penetration rates are probably attributable to the presence of decreasing amounts of ice with increasing soil depth at this site.

Dielectric and electrical conductivity profiles at each of the temperature site locations were taken before and after the heating process. Consistent with the temperature measurements, the data suggest that the greatest increase in liquid water content during heating occurred in the upper 100 mm, where dielectric values increased from between 5 and 12 to as high as 17, and electrical conductivity values increased from less than 20 μS/cm to as high as 100, μS/cm.

Stiffness data were collected both inside and outside of the enclosed test area after the heating period. CIVs, which increase with increasing ground stiffness, were measured at each pier and at five exterior locations. The results clearly demonstrate the efficacy of the heater in the thawing process. The average soil stiffness of the test locations within the enclosure was 75 percent less than that of the exterior test locations. DCP results obtained at the same locations after the heating period also show that the ground became much softer as a result of the infrared radiation, with reductions in penetration resistance most pronounced in the upper 200 mm for most of the sites.

Site 2—The soil at Site 2 was characterized as GC in the Unified Soil Classification System and contained an average total gravimetric water content of 20 percent in the upper 305 mm. The temperature measurements obtained at this site ranged from −5° C. to 2° C. inside under the heater, while the outside air temperature ranged from just below −22° C. to 0° C. The inside air temperature was measured about 300 mm above the ground. At this site, the heater was started at 7:30 p.m., again after 2 hours of temperature data collection by the dataloggers. Thus, a time of 0 hours in the charts corresponds to 5:30 p.m.

After approximately 27 hours of heating, or at 29 hours in the charts, the temperature at the 102 mm depth at two thermocouple sites increased above freezing, and by 36 hours the thawing had reached the 203-mm depth at one site. Average thaw penetration rates for this site were 3.8 mm/hr between the ground surface and the 102-mm depth and 14.4 mm/hr between the 102-mm and 203-mm depths.

Although the heater operated continuously for the next 30 hours, extremely low outside air temperatures limited further thaw penetration. By 70 hours in the charts, only two sites had reached temperatures above freezing at the 203-mm depth. However, the infrared heating did dissipate the ponded water during this time so that the ground surface became clearly visible.

At about 80 hours in the temperature charts, or at about midnight on the fourth day of the test, the construction site supervisor unfortunately allowed the propane tanks to empty, at which time the infrared heating ceased. By the time the dataloggers were stopped approximately 30 hours later, the ground had begun to refreeze so that all the thermocouple readings were again below 0° C. The effects of the thaw and refreeze are especially apparent at three sites, where both the dielectric and electrical conductivity values remain comparatively higher in the depth range of 100 mm to 200 mm than for shallower or deeper ground. These data suggest that the depth of refreeze had not yet approached the depth attained by the previous thawing.

CIVs were measured not only before and after the test, but also during the heating process. Test locations included the individual thermocouple sites and three locations outside the heated area. After about 70 hours, the ground stiffness at all of the sites except one decreased markedly during this time, with two sites experiencing reductions of 85 and 93 percent.

This research investigated the efficacy of low-intensity, radiant, infrared heating for inducing thawing in frozen ground. Specifically, the performance of a 22-kW infrared tube heater suspended between 2.0 m and 2.4 m above the ground was evaluated. Two sites in northern Utah were instrumented with thermocouple piers for field testing, and dielectric and electrical conductivity measurements were obtained together with CIVs and penetration resistance to assess the extent of thawing over periods from 3 days to 5 days in length.

The heater was observed to be extremely effective in melting snow and ice layers from the ground surface and in causing thawing of frozen ground as deep as 305 mm immediately beneath the heater assembly when air temperatures were not extraordinarily low. At the piers closest to the burner control box, the heater effected thaw penetration rates varying from 3.8 mm/hr to 17.0 mm/hr. At distances between 2.4 m and 3.0 m away from the heater in the lateral direction, however, the observed depth of thawing was reduced to less than 203 mm at the Provo site and less than 102 mm at the Park City site. This suggests that a combination of a greater number of heaters, higher heating intensity, or improved reflector design may be useful in uniformly distributing sufficient heat over the ground to cause thawing. Suspending the heater at various heights for different configurations may also be necessary to optimize the desired radiation intensity at the ground surface.

The preceding description has been presented only to illustrate and describe exemplary embodiments. It is not intended to be exhaustive or to limit the disclosure to any precise form disclosed. Many modifications and variations are possible in light of the above teaching. It is intended that the scope of the disclosure be defined by the following claims.

1. A method for caring for a surface comprising treating the surface with infrared radiation from at least one heat source placed near the surface.

2. The method according to claim 1, wherein said surface is prepared or maintained for activity selected from the group consisting of masonry work, concrete pouring, concrete curing, stucco application, stucco curing, tiling, trenching, dry wall taping, dry wall mudding, and painting.

3. The method according to claim 1, wherein the surface is treated in preparation for a construction activity.

4. The method according to claim 1, wherein the heat source comprises an infrared tube heater.

5. A method for caring for a surface for construction activity comprising:
identifying the surface to be treated;
sectioning off the identified surface;
positioning at least one infrared heat source, directed towards the surface; and
operating the heat source to provide thermal energy to the surface.

6. The method according to claim 5, wherein the surface is prepared or maintained for activity selected from the group consisting of masonry work, concrete pouring, concrete curing, stucco application, stucco curing, tiling, trenching, dry wall taping, dry wall mudding, and painting.

7. The method according to claim 5, wherein the surface is treated in preparation for a construction activity.

8. The method according to claim 7, wherein the surface is treated during the construction activity.

9. The method according to claim 8, further comprising continuously treating the surface with the at least one infrared heat source.

10. The method according to claim 5, wherein the heat source comprises an infrared tube heater.

11. The method according to claim 5, wherein the surface for preparation comprises a vertical wall.

12. The method according to claim 5, further comprising directing the infrared radiation through a wall towards the surface.

13. The method according to claim 5, further comprising sectioning of the surface to be treated with a canopy structure.

14. The method according to claim 13, further comprising suspending said at least one infrared heat source from said canopy structure.

15. The method according to claim 12, wherein the canopy is mobile.

16. A method for preparing the ground for concrete pouring comprising:
identifying a surface to be treated;
assembling a canopy above the surface;
hanging an infrared tube heater from the canopy; and
angling a radiation output of the infrared tube heater towards the ground.

17. A method according to claim 16, wherein the canopy comprises a lightweight framework.

18. A method according to claim 16, wherein the canopy is covered with a plastic cover.

19. A method according to claim 16, further comprising allowing the heat source to treat the surface until the state of the ground is sufficient for pouring concrete determined according to a building code.

20. A method according to claim 17, wherein the canopy is mobile.

21. A system for providing thermal energy to a surface comprising:
an infrared thermal energy source; and
a positioning structure coupled to said infrared thermal energy source;
wherein said positioning structure is configured to orient said infrared thermal energy source such that infrared radiation emitted from said infrared thermal energy source is directed to said surface.

22. The system of claim 21, wherein said infrared thermal energy source comprises an infrared tube heater.

23. The system of claim 21, wherein said positioning structure comprises a canopy.
